(19) United States
(12) Patent Application Publication
(10) Pub. No.: US 2009/0252277 A1
(43) Pub. Date: Oct. 8, 2009

(54) Upper Plenum Structure of Cooled Pressure Vessel for Prismatic Very High Temperature Reactor

(75) Inventors: Min-Hwan KIM, Daejeon (KR); Hong-Sik LIM, Daejeon (KR); Dong-Ok KIM, Daejeon (KR); Jong-Hwa CHANG, Gyunggi-Do (KR); Won-Jae LEE, Daejeon (KR)

Correspondence Address: ARENT FOX LLP, 1050 CONNECTICUT AVENUE, N.W., SUITE 400, WASHINGTON, DC, 20036, US

(73) Assignees: KOREA ATOMIC ENGERGY RESEARCH INSTITUTE, Daejeon (KR); KOREA HYDRO & NUCLEAR POWER CO., LTD., Seoul (KR)

(21) Appl. No.: 12/202,942

(22) Filed: Sep. 2, 2008

(30) Foreign Application Priority Data
Apr. 7, 2008 (KR) 10-2008-0032012

(51) Int. Cl. G21C 15/02; G21C 15/28

(52) U.S. Cl. 376/385; 376/381; 376/383; 376/386; 376/389

(57) ABSTRACT

An upper plenum structure of a cooled pressure vessel for a prismatic very high temperature reactor which secures a space for coolant to supply to a core and also supports an upper reflector located inside a graphite structure on top of the core. The upper plenum structure includes a cavity structure where the coolant goes down in the upper plenum structure, a plurality of upper reflector supports formed with the cavity and supporting the upper reflector located on top thereof, and a plurality of coolant distributing blocks. Each of the coolant distributing blocks is coupled with a bottom portion of a respective one of the upper reflector supports and is located on top of the core in order to distribute the coolant collected in a cavity, formed by the upper reflector support, to the core. The coolant distributing blocks cooperate with the upper reflector supports to define the cavity structure.

### BACKGROUND OF THE INVENTION

1. Field of the Invention

The present invention relates to an upper plenum structure of a cooled pressure vessel for a prismatic very high temperature reactor, and more particularly, to an upper plenum structure which secures a space for coolant to supply to a core and also supports an upper reflector located inside a graphite structure on top of the core.

2. Description of the Related Art

For a very high temperature (gas) reactor, coated particles of nuclear fuel, layered with thermostable carbon and silicon carbide, are used as fuel; thermo-resistant graphite is used as a moderator and a structural frame of a pressure vessel; and the helium is used as a coolant. For these reasons, a high gas outlet temperature of more than 950° C., which cannot be obtainable in other types of nuclear reactors, can be produced with inherent passive safety by using heat generated from this nuclear reactor. The high temperature generated from this reactor can be used for many purposes such as highly efficient generation of the electric power, hydrogen production, and the like.

As one kind of the fuel for the very high temperature reactors, a block-type fuel is used and it comes with two types: a multi-hole block and a pin-in block. The multi-hole block consists of rod-shaped fuel compacts inserted into a graphite block structure with longitudinally parallelized multiple passages and some of the passages are used as a coolant flow channel. The pin-in block is constructed by a method of inserting the fuel rods, wherein the fuel compacts are inserted into the graphite sleeves, into the coolant flow channel among the passages of the graphite block structure.

In the very high temperature reactors, since a coolant inlet temperature as well as the outlet temperature is higher than 490° C., high-chrome steel is chosen as the material for the pressure vessel. However, high-chrome steel has never been used in the pressure vessel of a commercial nuclear reactor and there are many challenges with the supply and the production of this material. As a result, a specific design of the cooled pressure vessel is needed in order to choose SA-508/533 steel, already verified in the commercial light-water reactors, as the material for the pressure vessel.

In the design of the cooled pressure vessel for a prismatic (block-type) very high temperature reactor using the verified material in the commercial light-water reactor, the flow channels are chosen for the supply of the high-temperature coolant into a core through the graphite structure around the prismatic core such that they do not come into contact with the pressure vessel. In the prismatic very high temperature reactor of the related art, the pressure vessel is structured to contact directly with the high-temperature coolant. FIG. 1 is a schematic view illustrating an inlet flow concept of the prismatic very high temperature reactor of the related art, and FIG. 2 is a horizontal sectional view illustrating the prismatic very high temperature reactor of the related art. As shown in the diagram, a high-temperature helium coolant with the temperature of 490° C., injected from the outside of an inlet pipe 1, is supplied to the upper area of the core through a coolant rising channel 5 located between a reactor pressure vessel 2 and a core support barrel 3. After the coolant is heated at the temperature of 950° C. by passing through the core, it is constructed to transfer into an energy conversion system through an exit duct 20. Since the coolant inlet flow channel of the related art is structured for the high-temperature helium with the temperature of 490° C. or more to contact the reactor pressure vessel 2 as shown FIGS. 1 and 2, the temperature of the reactor pressure vessel 2 exceeds the allowable temperature of the material for the commercial light-water pressure vessel, SA-508/533, and a high temperature heat-resistant steel, 9Cr-1Mo—V, is chosen as a candidate material for the pressure vessel of the prismatic very high temperature reactor of the related art. In FIGS. 1 and 2, to explain, number 4 stands for a block-type core, number 6 for a heat insulator, number 7 for an upper reflector, number 8 for an inner reflector, number 9 for an outer reflector, number 10 for a permanent reflector, and number 11 for a lower reflector.

Not only has the high temperature heat-resistant steel never been used for the actual reactor pressure vessel before, but also more research and improvements are needed for a well-established welding procedure and related to the supply/demand of the material. Therefore, there is a problem with the application in a middle/short period of time. Especially, in case of the prismatic very high temperature reactor with the core outlet temperature of 950° C., a new structural design is needed in order to use the pressure vessel for the commercial light-water reactor because of an accompanied rising temperature of the inlet coolant.

Korean Patent Application No. 10-2007-0076313, which was previously filed by the inventor to solve the above mentioned problems, discloses a structure of the cooled pressure vessel for maintaining the temperature of the pressure vessel within the allowable temperature, 371° C., of the SA-508/533 steel which was verified as the pressure vessel material in the commercial light-water reactor, in order to use the SA-508/533 steel for the prismatic very high temperature reactor.

As these structures are shown in FIGS. 3 and 4, FIG. 3 is a schematic view illustrating the previously-filed cooled pressure vessel for the prismatic very high temperature reactor, and FIG. 4 is a horizontal sectional view illustrating the prismatic very high temperature reactor with the concept of the previously-filed cooled pressure vessel.

As shown in the diagram, the configuration of the previously-filed application by the inventor is characterized by the change of the coolant flow path and an additional cooling method for the pressure vessel, the coolant flow path of the prismatic very high temperature reactor are changed to pass by the graphite structure in order to prevent the direct contact of the high-temperature inlet coolant with the reactor pressure vessel 2. The graphite structure is located inside the core support barrel 3 with a regular space from the inside wall of the reactor pressure vessel 2, and includes an upper reflector 7 formed above the block-type core 4, an inner reflector 8 located inside the block-type core 4, an outer reflector 9 located outside the circumference of the prismatic core 4, a permanent reflector 10 located outside the circumference of the outer reflector 9, and a lower reflector 11 located below the prismatic core 4.

In the inventor's previously-filed application, the coolant is supplied, instead of via the inlet pipe 1, via a coolant flow channel consisting of an inlet plenum 13, a rising flow channel 12 and an upper plenum 14, which are formed inside of the graphite structure, in order to prevent the high-temperature helium coolant from directly contacting the reactor pressure vessel by, and thus the SA-508/533 steel can be used as the material for the reactor pressure vessel of the prismatic very high temperature reactor with the outlet nozzle's temperature of 950° C. With the coolant flow channel, the temperature of the pressure vessel can be controlled within the allowable temperature of 371° C. of the SA-508/533 steel.

The coolant flow channel consists of the inlet plenum 13, the rising flow channel 12 and the upper plenum 14, all of which are located inside the graphite structure. The inlet plenum 13 calls for a ring-shaped space in the lower reflector 11 and connects the inlet pipe 1 with the rising flow channel 12. The coolant supplied through the inlet pipe 1 expands and spreads, and then moves to the rising flow channel 12. The rising flow channel 12 consists of a plurality of open holes inside the permanent reflector 10 and connects the inlet plenum 13 with the upper plenum 14. The upper plenum 14 is located inside the upper reflector and supplies the coolant, passed through the rising flow channel 12, to the core 4. The upper plenum includes a plurality of mixing cavities 16 and slits 15. Several (more than 2) open holes of the rising flow channels 12 are bundled and connected with one mixing cavity 16, and then lead to the core by passing through more than two slits. This configuration will prevent an irregular flow, transferred from the inlet plenum 13 into the rising flow channel 12, from supplying directly into the core 4 and mitigate the non-uniformity of the flow as well. It also makes upper graphite structures be easily loaded, and an upper heat insulator of the pressure vessel does not need to be installed for preventing the high-temperature helium flow lifted from the core from contacting the pressure vessel when the reactor is tripped or is in accidents. In case of the accident, enhancing a natural circulation is easily executed as a method to delete the heat from the core.

When the coolant is supplied to the structure with the above configuration via the inlet pipe 1, the coolant passes through the inlet plenum 13, the rising flow channel 12, and the upper plenum 14. After having gone down to the prismatic core 4, the coolant will be discharged through the exit duct 20. Even though the temperature at the exit duct reaches a temperature of 950° C. in the prismatic very high temperature reactor, the temperature of the pressure vessel can be maintained inside the temperature of 371° C., which is the allowable temperature of the SA-508/533 steel.

In the inventor's previous invention, the coolant inlet flow path located inside the graphite structure, structured to prevent the coolant from contacting directly with the high-temperature pressure vessel, consists of the inlet plenum, the rising flow channel and the upper plenum. The coolant provided from the outside of a concentric double pipe gathers together in the inlet plenum, and then moves to the upper area of the core by passing through the multiple cylindrical passages in the rising flow channel. The upper plenum consists of a plurality of small mixing cavities, slits and a big upper core cavity; several of the rising flow channel passages are bundled up, connected with a small mixing cavity, and then supplied into the core by passing through the slit.

Although the upper plenum plays an important role in the coolant inlet flow path by supplying the coolant transferred from the rising flow channel to the entrance of the core, there has been no detailed structural design on how to make the necessary structure by loading the graphite structure. Therefore, a detailed structural design is needed to realize the coolant inlet flow path in the prismatic very high temperature reactor.

### SUMMARY OF THE INVENTION

The objective of the present invention is to solve the above mentioned problems with the related art, and embodiments of the present invention provide an upper plenum structure of a cooled pressure vessel for a prismatic very high temperature reactor, wherein the upper plenum structure secures a flow channel, through which a coolant can be supplied to a core, and plays a role of supporting an upper reflector.

To achieve the above mentioned objective and remove the defects of the related art, the present invention provides an upper plenum structure of a cooled pressure vessel design of a very high temperature gas reactor, the cooling structure of which has a graphite structure and constructed to supply helium as a coolant via an inlet pipe to cool down a prismatic core of the reactor and then discharge the coolant via an exit duct, wherein the graphite structure includes an upper reflector located inside a core support barrel with a regular gap from a reactor pressure vessel, an inner reflector located inside the prismatic core, an outer reflector located at outer circumferential portions of the prismatic core, a permanent reflector located at outer circumferential portions of the outer reflector, and a lower reflector located at a lower portion of the prismatic core.

Here, the upper plenum structure includes: a cavity structure where the coolant goes down in the upper plenum structure, the cavity structure including a mixing cavity, which bundle up a plurality of the rising flow channels to moderate a non-uniformity of the flow generated in the inlet plenum, and a plurality of the slits, which split again the coolant passed through the mixing cavity and lead to an entrance of the prismatic core; a plurality of upper reflector supports formed with the cavity and supporting the upper reflector located on top thereof; and a plurality of coolant distributing blocks, wherein each of the coolant distributing blocks is coupled with a bottom portion of a respective one of the upper reflector supports and is located on top of the prismatic core in order to distribute the coolant collected in a space, formed by the upper reflector support, to the prismatic core, wherein the coolant distributing blocks cooperate with the upper reflector supports to define the cavity structure.

The upper reflector support may be structured to form the mixing cavity where the coolant transferred from the rising flow channel gathers together before it moves to the prismatic core and to adjust a depth of the cavity according to cavity length.

The upper reflector support may include a cylindrical column to form the cavity, which combines the transferred coolant from the mixing cavity via the slits before it moves to the prismatic core, and is machined at an edge of a connecting portion to have a round shape so as to absorb thermal expansion generated from another graphite structure.

Each of the coolant distributing blocks may include: a support installation seat formed in a central portion thereof where a respective one of the upper reflector supports is installed; and a plurality of coolant flow channels for supplying the coolant collected in the cavity of the upper plenum to a plurality of coolant channels, which are formed in nuclear fuel blocks under the coolant flow channels.

The coolant distributing block may have a handling hole formed inside a bottom of the support installation seat, for equipment dealing with the coolant distributing block.

The coolant distributing block may be formed with a plurality of a small coolant flow channels, each of which connects a respective one of the multiple coolant flow channels located around the support installation seat with the coolant channel of the nuclear fuel blocks.

The coolant distributing block may be formed with a cavity of dome structure connecting a plurality of holes in an upper part of it around the support installation seat, with the coolant channel of the nuclear fuel blocks.

The coolant distributing block may have a handling hole formed inside a bottom of the support installation seat, for equipment dealing with the coolant distributing block, and an alignment pin formed in a bottom thereof to align the coolant distributing block with the nuclear fuel block.

The coolant distributing block may have a dowel hole formed in a lower portion thereof, opposite a hole formed in an upper part of the coolant distributing block, to align a small coolant flow channel of the coolant distributing block with the coolant channel, wherein a dowel pin is inserted into the dowel hole.

The present invention is a useful invention with an advantage of enabling an internal flow channel design to prevent the high-temperature inlet coolant from contacting with the pressure vessel by providing the detailed structural design of the upper plenum for the prismatic very high temperature reactor and also is expected to have huge utilization in the industry.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view illustrating an inlet flow concept of a prismatic very high temperature reactor of the related art;

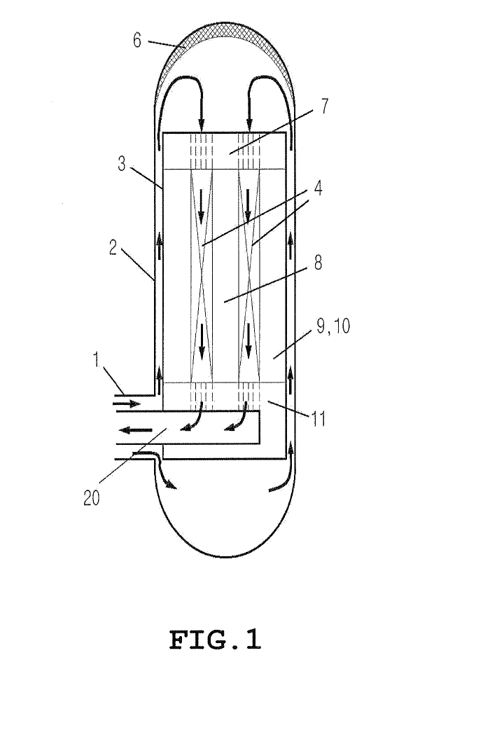

FIG. 2 is a horizontal sectional view illustrating the prismatic very high temperature reactor of the related art;

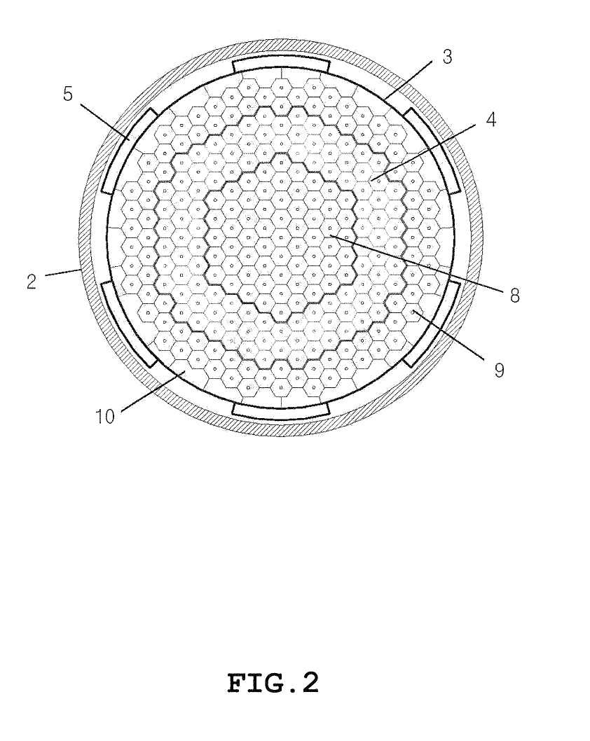

FIG. 3 is a schematic view illustrating a previously-filed cooled pressure vessel for the prismatic very high temperature reactor;

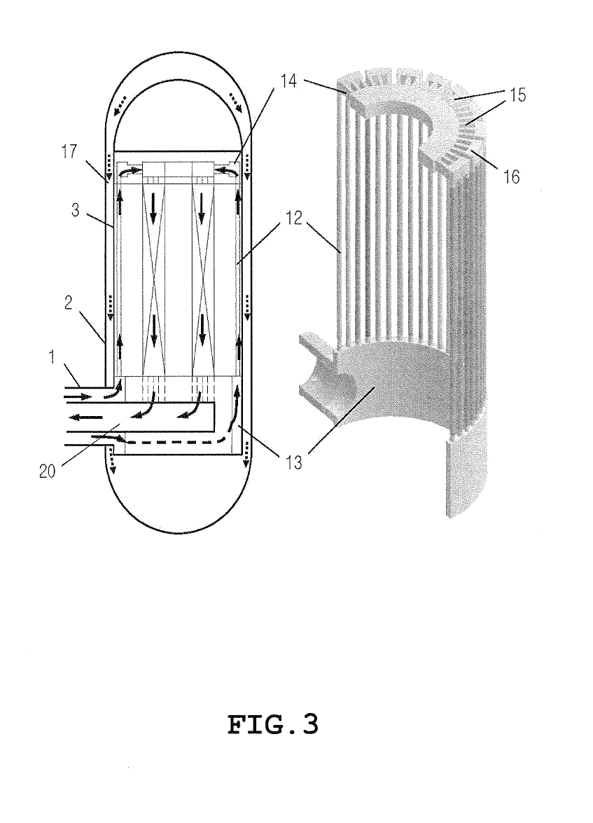

FIG. 4 is a horizontal sectional view illustrating the prismatic very high temperature reactor with the concept of the previously-filed cooled pressure vessel;

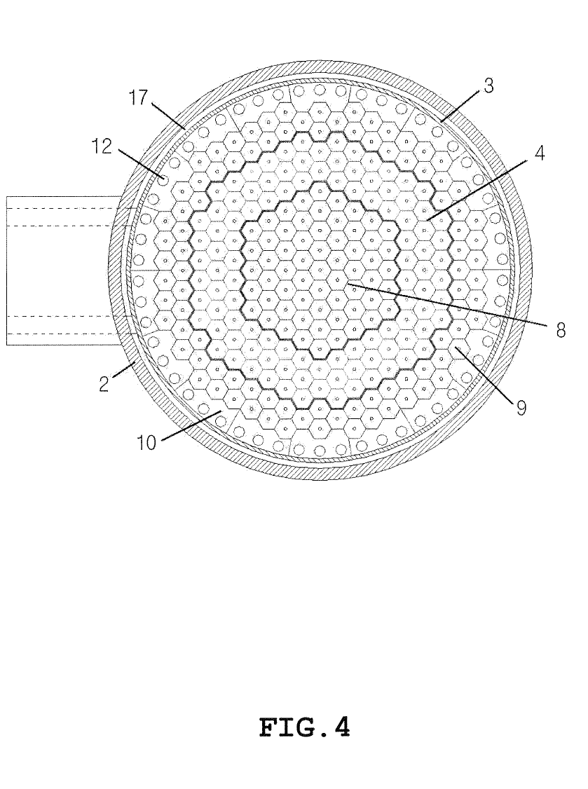

FIG. 5 is a cross sectional view illustrating an upper plenum in accordance with the present invention;

FIG. 6 is a perspective view illustrating coolant distributing blocks in accordance with the present invention;

FIG. 7 is a block diagram illustrating the coolant distributing block for an embodiment in accordance with the present invention; and

FIG. 8 is a block diagram illustrating the coolant distributing block for another embodiment in accordance with the present invention.

### DETAILED DESCRIPTION OF THE INVENTION

The construction and the operation of the present invention will now be described more in detail with reference to the accompanying drawings, in which exemplary embodiments thereof are shown. In the following description of the present invention, a detailed description of known functions and components incorporated herein will be omitted when it may make the subject matter of the present invention rather unclear.

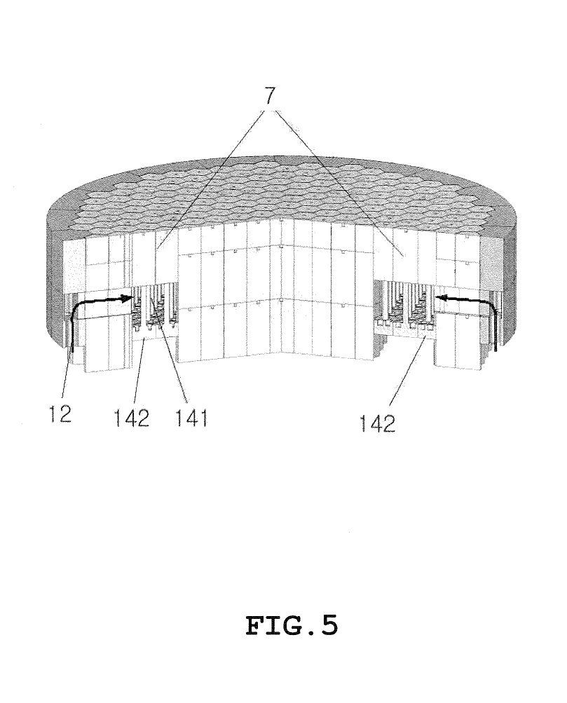

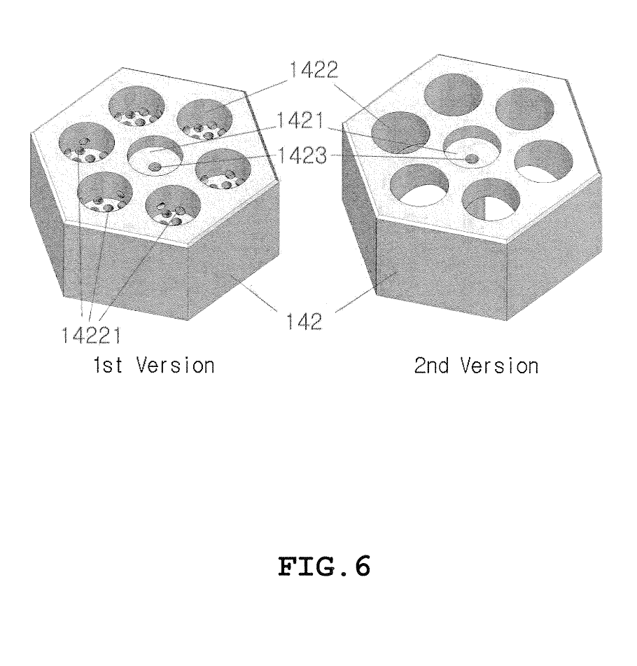

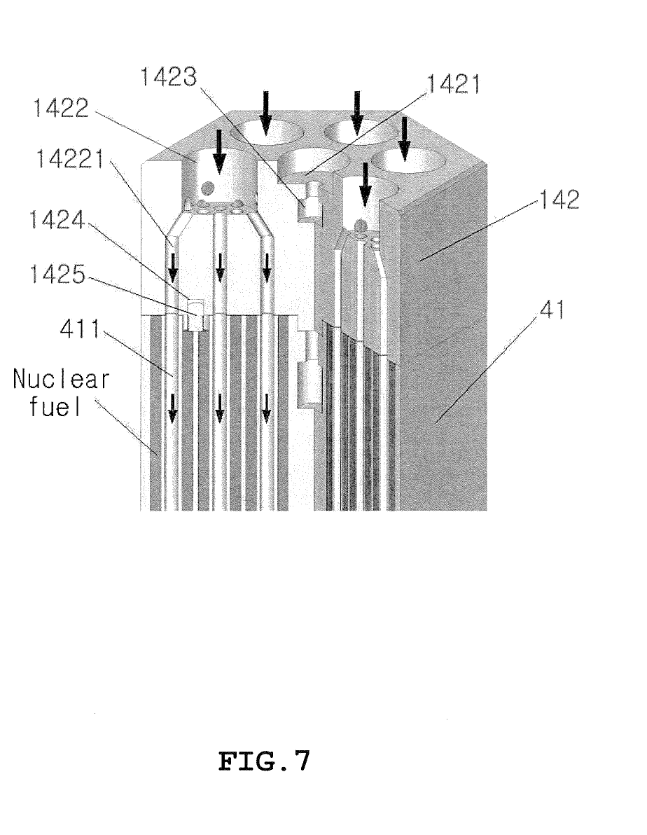

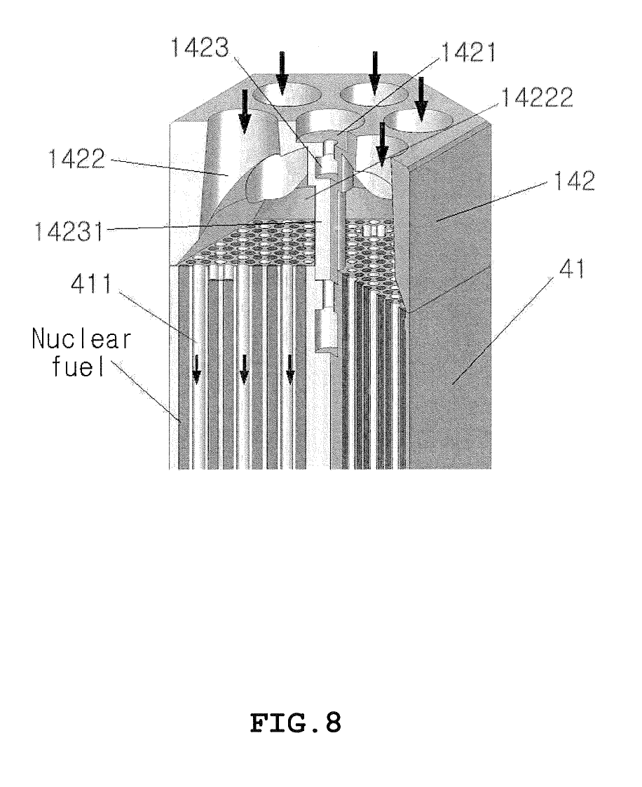

FIG. 5 is a cross sectional view illustrating an upper plenum in accordance with the present invention; FIG. 6 is a perspective view illustrating coolant distributing blocks in accordance with the present invention; FIG. 7 is a block diagram illustrating the coolant distributing block for an embodiment in accordance with the present invention; and FIG. 8 is a block diagram illustrating the coolant distributing block for another embodiment in accordance with the present invention.

The present invention constitutes an upper plenum structure 14 as shown in FIG. 5 by employing an upper reflector support 141 and a coolant distributing block 142.

The upper reflector support 141 supports an upper reflector 7 located on the area of a prismatic (block-type) core 4 in order to secure a space for putting together coolant, supplied from a rising flow channel 12, before the coolant moves to the prismatic core 4. The upper reflector supports 141 are cylindrical columns and their edges are machined to form a round shape to absorb a small deformation due to thermal expansion and irradiation.

The coolant distributing block 142 secures a space to install the upper reflector support 141 and also provides a coolant flow channel connecting an upper plenum 14 and coolant channels of the prismatic core 4.

For the configuration of the coolant distributing block 142, two versions are proposed as shown in FIG. 6. In both versions of the coolant distributing block 142, a support installation seat 1421, where the upper reflector support 141 can be installed, is located on the top center, and a plurality of coolant flow holes 1422 are provided around the support installation seat 1421. A handling hole 1423 is formed inside the bottom of the support installation seat 1421 so as to provide a space for the insertion of the handling tool into a handling hole 1423 when the coolant distributing block 142 is installed or separated. The handling equipment, herein, is a machine installed on the upper portion of a (gas) reactor when the graphite block such as the upper reflector support is installed in the reactor and the handling tool is formed to hold the block and install it at the needed position. The handling tool can be inserted into the handling hole and be fixed by widening of both sides.

More detailed connecting structures for the coolant distributing block and the coolant channels of the nuclear fuel are illustrated in FIGS. 7 and 8 for the first version and the second version, respectively.

In the first version, there are a plurality of the small coolant flow channels 14221 which are connecting passages with a coolant channel 411 of a nuclear fuel block 41 forming the prismatic core 4 in the surrounding coolant flow holes 1422 around the support installation seat 1421 in order that the collected coolant in the upper plenum can be supplied to the coolant channels of the nuclear fuel. In the lower portion of the coolant distributing block, a dowel hole 1424 where a dowel pin 1425 can be installed is formed to face a hole formed in the top portion of the nuclear fuel block, and the coolant flow channel 14221 and the coolant channel 411 can be arranged by connecting both portions with the dowel pin.

For the second embodiment, a dome-structured cavity 14222 is directly connected with the coolant channel instead of with the plurality of the holes which connect the coolant channel 411. In the lower part of the handling hole 1423, there is an arranging pin 14231 which sets the coolant distributing block and the nuclear fuel block to be aligned with each other.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An upper plenum structure of a cooled pressure vessel design of a very high temperature reactor, the cooling structure of which has a graphite structure and constructed to supply helium as a coolant via an inlet pipe to cool down a prismatic core of the reactor and then discharge the coolant via an exit duct, wherein the graphite structure includes an upper reflector located inside a core support barrel with a regular gap from a reactor pressure vessel, an inner reflector located inside the prismatic core, an outer reflector located at outer circumferential portions of the prismatic core, a permanent reflector located at outer circumferential portions of the outer reflector, and a lower reflector located at a lower portion of the prismatic core,
the upper plenum structure comprising:
a cavity structure where the coolant goes down in the upper plenum structure, the cavity structure including a mixing cavity, which bundle up a plurality of the rising flow channels to moderate a non-uniformity of the flow generated in the inlet plenum, and a plurality of the slits, which split again the coolant passed through the mixing cavity and lead to an entrance of the prismatic core;
a plurality of upper reflector supports formed with the cavity and supporting the upper reflector located on top thereof; and
a plurality of coolant distributing blocks, wherein each of the coolant distributing blocks is coupled with a bottom portion of a respective one of the upper reflector supports and is located on top of the prismatic core in order to distribute the coolant collected in a space, formed by the upper reflector support, to the prismatic core, wherein the coolant distributing blocks cooperate with the upper reflector supports to define the cavity structure.

2. The upper plenum structure according to claim 1, wherein the upper reflector support is structured to form the cavity where the coolant transferred from the rising flow channel gathers together before it moves to the prismatic core and to adjust a depth of the cavity according to a length thereof.

3. The upper plenum structure according to claim 1, wherein the upper reflector support comprises a cylindrical column to form the cavity, which combines the transferred coolant from the rising flow channel before it moves to the prismatic core, and is machined at an edge of a connecting portion to have a round shape so as to absorb thermal expansion generated from another graphite structure.

4. The upper plenum structure according to claim 1, wherein each of the coolant distributing blocks includes:
a support installation seat formed in a central portion thereof where a respective one of the upper reflector supports is installed; and
a plurality of coolant flow holes for supplying the coolant collected in the cavity of the upper plenum to a plurality of coolant channels, which are formed in nuclear fuel blocks under the coolant distribution blocks.

5. The upper plenum structure according to claim 4, wherein the coolant distributing block has a handling hole formed inside a bottom of the support installation seat, for equipment dealing with the coolant distributing block.

6. The upper plenum structure according to claim 4, wherein the coolant distributing block is formed with a plurality of small coolant flow channels, each of which connects a respective one of the multiple coolant flow holes located around the support installation seat with the coolant channel of the nuclear fuel blocks.

7. The upper plenum structure according to claim 4, wherein the coolant distributing block is formed as a dome-structured cavity, the lower structure of which is connected with the coolant channel of the nuclear fuel blocks, so as to directly join with the coolant channel.

8. The upper plenum structure according to claim 7, wherein the coolant distributing block has a handling hole formed inside a bottom of the support installation seat, for equipment dealing with the coolant distributing block, and an alignment pin formed in a bottom thereof to align the coolant distributing block with the nuclear fuel block.

9. The upper plenum structure according to claim 4, wherein the coolant distributing block has a dowel hole formed in a lower portion thereof, opposite a hole formed in an upper part of the coolant distributing block, to align a small coolant flow channel of the coolant distributing block with the coolant channel, wherein a dowel pin is inserted into the dowel hole.
